(19) United States
(12) Patent Application Publication
(10) Pub. No.: US 2003/0048296 A1
(43) Pub. Date: Mar. 13, 2003

(54) Method & apparatus for enhancing the graphical user interface presented by an application

(76) Inventors: Paul Cullen, Seattle, WA (US); Brock Gardner, Seattle, WA (US); Michael Jones, Bellevue, WA (US)

Correspondence Address: Nixon & Vanderhye P.C., 8th Floor, 1100 North Glebe Road, Arlington, VA, 22201, US

(21) Appl. No.: 10/226,113

(22) Filed: Aug. 23, 2002

Related U.S. Application Data
(60) Provisional application No. 60/318,336, filed on Sep. 12, 2001.
(60) Provisional application No. 60/391,943, filed on Jun. 28, 2002.

(51) Int. Cl. G09G 5/00

(52) U.S. Cl. 345/744

(57) ABSTRACT

A new way to “webify” host applications and streamline them for different user groups, without revising the original application on the host, enhances the usability of host applications in a web environment—providing a graphical user interface and streamlining the flow of information for current or new user groups. Host application materials are analyzed as source material, rather than as a literal script. Processing can alter the way host information is presented—both in terms of appearance and sequence—making it possible to present just the information user groups care about, with a new graphical interface that's familiar to today's PC users. Additional components using JavaScript control how information from the host is presented in a web browser, without modifying the original application on the host system. Customization is based on how host systems work, and is used to adapt host applications to the web and to design effective graphical interfaces that make host applications easy to use. This unique blend allows a “webified” application to be available quickly, and to give the precisely desired results to its users.

### CROSS-REFERENCES TO RELATED APPLICATIONS

This application claims priority from provisional application No. 60/318,336 filed Sep. 12, 2001 and provisional application No. 60/391,943 filed Jun. 28, 2002, the entire disclosures of which are incorporated herein by reference.

### STATEMENT REGARDING FEDERALLY SPONSORED RESEARCH OR DEVELOPMENT

Not applicable.

### BACKGROUND AND SUMMARY OF THE INVENTION

As the web becomes the new medium for business communications, more and more companies are looking to convert non-web-based applications (e.g., Host Applications) to web-based environments as a way to quickly publish their corporate information and applications on the web. The benefits, both in terms of cost savings and faster information flow, are hard to ignore. As companies move their host and other applications to the web, however, they often find that they are extending access to new user groups—suppliers, distributors, business partners, and even customers—with usability requirements that differ from those of users inside the company.

FIG. 1 shows an example arrangement that can be used to provide connectivity between an existing host or other computer and a variety of web-based or other standard devices such as personal computers, personal data assistants, cellular telephones, etc. As shown in FIG. 1, a centralized (e.g., host) computer 10 is designed to provide interactive displays and to receive input from one or more terminals 12. Computer 10 typically is a “host” mini-computer or main frame computer designed to communicate with terminals 12 using a conventional data stream such as IBM 3270, IBM 5250, VT100 or other conventional terminal protocol. In its original design, for example, computer 10 might have been intended to communicate using such terminal protocols with so-called “dumb” terminals having little intelligence and providing little functionality beyond a display, a keyboard and a small memory buffer and associated logic. This type of “host” computer 10 coupled to “dumb” terminals 12 (i.e., a centralized computing architecture) was very popular prior to the 1990s, and continues to be widely used today for certain applications. For example, even though local and wide area networks and associated distributed computing have largely replace the older, centralized host computer architectures of the past for many applications, many business and governmental entities continue to rely on centralized computers for legacy and other applications. It is common, for example, to find accounting, order fulfillment, database and other important or critical application functions running on centralized computers 10. The cost and inconvenience of rewriting customized software so that it will run on different computing platforms is substantial. Therefore, many business and governmental entities have chosen to update their systems by retaining centralized computer 10 and providing additional connectivity options.

For example, one connectivity model is to connect a network server 12 to centralized computer 10. Network server 12 in turn provides connectivity via a network 14 with any number of different types of computing platforms including, for example, personal computers 16, personal data assistants 18, cellular telephones 20, etc. In this exemplary arrangement, server 12 communicates via network 14 with appliances 16, 18, 20 in a conventional Internet (or other) protocol such as HTTP. Similarly, each of appliances 16, 18, 20 may include a conventional web browser implemented in hardware and/or software that enables it to display HTML or other markup language web or other information pages or displays.

Typically, in order to provide compatibility, server 12 and/or appliances 16, 18, 20 include additional functionality that allows the appliances to “emulate” or otherwise be seen by computer 10 act like a terminal 12. For example, appliances 16, 18, 20 may provide multiple functions or modes—one of which is to act like terminal 12 in receiving and displaying screens of information from computer 10 and collecting and providing responsive user inputs to be transmitted back to the centralized computer 10 for processing (all in a manner that is compatible with the data streams sent and expected by centralized computer 10).

One exemplary illustrative such design is implemented by a product called Reflection for the Web sold by WRQ of Seattle Wash. In this exemplary arrangement, server 12 and/or appliances 16, 18, 20 provide “emulation” functionality used to interface successfully with centralized computer 10. In one exemplary arrangement, for example, server 12 executes emulation software and produces corresponding HTML, Java, other web markup languages or other pages which the server then transmits over network 14 to appliances 16, 18, 20 for display using conventional web browser functionality. In another exemplary arrangement, server 12 encodes centralized computer 10's display stream for transport via network 14, and appliances 16, 18, 20 (and/or server 12) execute terminal emulation functionality to convert the display stream into corresponding displays (in this latter arrangement, server 12 may actually comprise a communications adapter, gateway or other functionality, and may be incorporated within computer 10).

An advantage of using the FIG. 1 arrangement is that standard conventional web-based or other appliances 16, 18, 20 providing a conventional standard display and user interaction conventions can interact with centralized computer 10. Thus, for example, it becomes possible to allow users to interact with centralized computer 10 via a direct local or wide area network or the Internet.

One approach to terminal emulation is to simply present exactly the same screens on the terminal emulator that centralized computer 10 displays on an actual terminal 12. While this approach is the most straightforward to implement, it suffers from certain disadvantages. For example, screens intended for display on terminal 12 often rely on special-purpose keys on the terminal 12's keyboard for ease of use. Appliances such as personal computer 16, personal digital assistant 18, cellular telephone 20 and the like typically do not have (or cannot be counted on to have) such special-purpose keys. While it is possible to remap existing keys on appliances 16, 18, 20 to special-purpose functions, the remapping can sometimes be difficult to remember and somewhat confusing to use.

Another distinct disadvantage in simply presenting the same screens that centralized computer 10 generates has to do with the advances in graphical user interfaces that have occurred over the last few decades. For example, the wide spread adoption of the mouse, the stylus, and other “pointing” devices has made it much easier for users to interact with graphical user interfaces. However, many centralized computers 10 and/or associated legacy software were not designed for pointing devices. Rather, such screens often must be completed by tabbing or “field exit” keying to advance the cursor from one field to the next. In contrast, users are now used to the convenience offered by Windows, Web, PDA and other graphical user interfacing screens which use a pointing device to direct data input position. Similar situations exist with respect to pull-down menus, color, auto-fill fields, and other modem graphical user interface features.

For these and other reasons, it has become desirable to convert not simply the communications protocol, but also the format of the screens themselves. One example of such conversion is to “webify” the screen formats—i.e., converting them to a format that is more like screens initially designed to be displayed using a web browser. Such screen format conversion ideally allows users to take advantages of the ease-of-use features of modern web browsers including pointing devices, pull-down menus, color displays, scrolling, hypertext links, etc.

Some companies who offer web-based terminal emulation products also offer products or services designed to “webify” host applications—giving them a graphical user interface that is familiar and easy for most users to navigate. There are several different approaches to “webifying” the host applications, but not all such approaches have been successful. One approach to convert host application data into web-based data has sometimes been termed “auto-rejuvenation.” “Auto-rejuvenation” products promise an easy way to give character-based host applications an interface familiar to today's mouse-driven users. They generally work by translating elements of a host application into their graphical interface equivalents. A numbered list, for example, might be translated into a pull-down menu. Data entry fields might be translated into editable text boxes. The host application functions in exactly the same way as before but presents a new, user-friendly GUI, instead of a terminal screen.

In theory, auto-rejuvenation products offer an “out-of-the-box” solution for webifying host applications. In reality, however, rejuvenating a host application is seldom as straightforward as it seems. For one thing, host applications generally run on a variety of host systems. Currently, most auto-rejuvenation products are limited to host applications that run on certain computers (e.g., IBM mainframes or IBM AS/400 systems). Then, there's the fact that many host applications were written in-house decades ago for a very specific purpose. This often means that the graphical user interfaces of these applications are as unique as the companies that use them. For this reason, using an auto-rejuvenation product on a proprietary host application often turns into a time-consuming, manual process, as it may be necessary to “teach” the auto-rejuvenation product about each screen of the host application.

Most importantly, however, auto-rejuvenation products often deliver results that fall short of what businesses really want to achieve. The reason for this is simple: as companies extend their corporate applications to new users, they often discover that the host applications they've used for years are too complicated and unwieldy for new users—especially those outside the company—to successfully navigate. Although rejuvenating a host application can make individual terminal screens look more like web pages, auto-rejuvenation products cannot change the flow or pace of the original application.

Take, for example, a distributor who needs to know when a shipment will arrive. Publishing an order tracking application on the web gives the distributor access to the data she needs. However, if the shipping schedule is buried six screens into a host application, rejuvenating a host application won't necessarily make the information more accessible—since the distributor will still have to navigate through six screens of irrelevant data to reach the information. And she may decide that picking up the phone is easier than using the web solution you've provided.

To solve these problems, we have invented a new way to “webify” or otherwise convert host or other applications and streamline them for different user groups, without need to revise the original application. The present invention enhances the usability of host applications in a web environment—providing a graphical user interface and streamlining the flow of information for current or new user groups.

In accordance with one aspect provided by a preferred example embodiment of the invention, display data can be effectively extracted from multiple host or other computer screens and repackaged into a smaller number of HTML web pages or other information displays. In accordance with this aspect provided by a preferred illustrative exemplary embodiment of this invention, host or other application materials are analyzed as source material, rather than as a literal script. For example, a host application may contain key information on three separate screens. Ideally, it would be desirable to consolidate this information onto a single web page. Or, the critical information web users care about might be buried several screens into the host application. It would be desirable to find a way to “jump” to the information, without requiring users to navigate through unfamiliar screens. Conventional auto-rejuvenation products, because they are limited to redrawing host applications screen-by-screen, are generally unable to do this. However, exemplary processes provided in accordance with aspects of a preferred exemplary embodiment of the present invention can.

Processing in accordance with aspects of a preferred exemplary illustrative embodiment of the present invention can alter the way host information is presented—both in terms of appearance and sequence—making it possible to present just the information user groups care about, with a new graphical interface that's familiar to today's PC users.

Customization in accordance with preferred exemplary embodiments of this invention is generally based on how host systems work, and are used to adapt host applications to the web and to design effective graphical interfaces that make host applications easy to use. This unique blend allows a “webified” application to be up and running quickly, giving desired results.

The preferred exemplary embodiment of this invention can quickly breathe new life into host applications at a relatively low cost. Together, they allow host applications to be presented with a new interface and flow, without need to modify the original host application. The preferred exemplary embodiment process can work with any host or other application—including for example applications on IBM mainframes, IBM AS/400, HP, UNIX, and OpenVMS systems to name a few.

In the exemplary embodiment, the physical component is a Java applet or Java servlet that does the recognition in mainframe, host and other computer environments.

Preferred exemplary embodiments offer the following illustrative features and advantages:

Can be used to provide a graphical user interface (GUI) to any host system supported by underlying terminal emulation.

The GUI can be formed by a full (i.e., entire) page on the screen—i.e., it is not limited to a little picture or portion of the screen.

Provides some elements and code that can be consistently reused.

Recognizes host screens and provides a way to navigate screens automatically.

Gathers information from several screens and bundles them into an HTML interface.

Can be used to dynamically generate new pages (e.g., in HTML format) using the host screen or HTML templates.

Allows one to redesign the whole flow of the process (for example, what used to be 30 screens in a host legacy screen display might be converted to a much smaller number of pages such as 3 or 5 pages).

Totally customizable.

Improves the user experience; complex host applications can be simplified.

Can easily consolidate several host screens into one HTML screen.

Can easily perform computations, data validation, business logic or screen navigation.

Provides increased efficiency in user experience as well as use of host system.

Runs as a Java applet in a browser when terminal emulation runs in browser (2-tier environment).

Runs as a Java servlet on a web server when terminal emulation runs on the server (3-tier environment).

Highly refined customization works with all terminal types supported by underlying terminal emulation.

User interface defined using JSP templates.

Uses, in combination, Screen Recognition, Auto-rejuvenation, as well as Operation/Navigation, Template & Form handling.

Operation/Navigation modules can be written in Java (client or server implementation) or in JavaScript (client implementation only).

User interface presented as HTML forms in a web browser.

Auto-rejuvenation works with all host types supported by the underlying emulation.

The terminal emulation uses a Java or other conventional API.

### BRIEF DESCRIPTION OF THE DRAWINGS

These and other features and advantages provided in accordance with exemplary and illustrative embodiments of the present invention may be better and more completely understood by referring to the following detailed description in conjunction with drawings, of which:

FIG. 1 shows an exemplary terminal emulation arrangement;

FIG. 2 shows an exemplary process for converting terminal based graphical user interfaces to web-based graphical user interfaces;

FIG. 3a shows the exemplary embodiment in a two-tier structure implemented as an illustrative Java applet running in a browser/client;

FIG. 3b shows the exemplary embodiment in a three-tier structure implemented as an illustrative Java servlet on a web server; and

FIGS. 4-5 show example illustrative “before and after” screen displays.

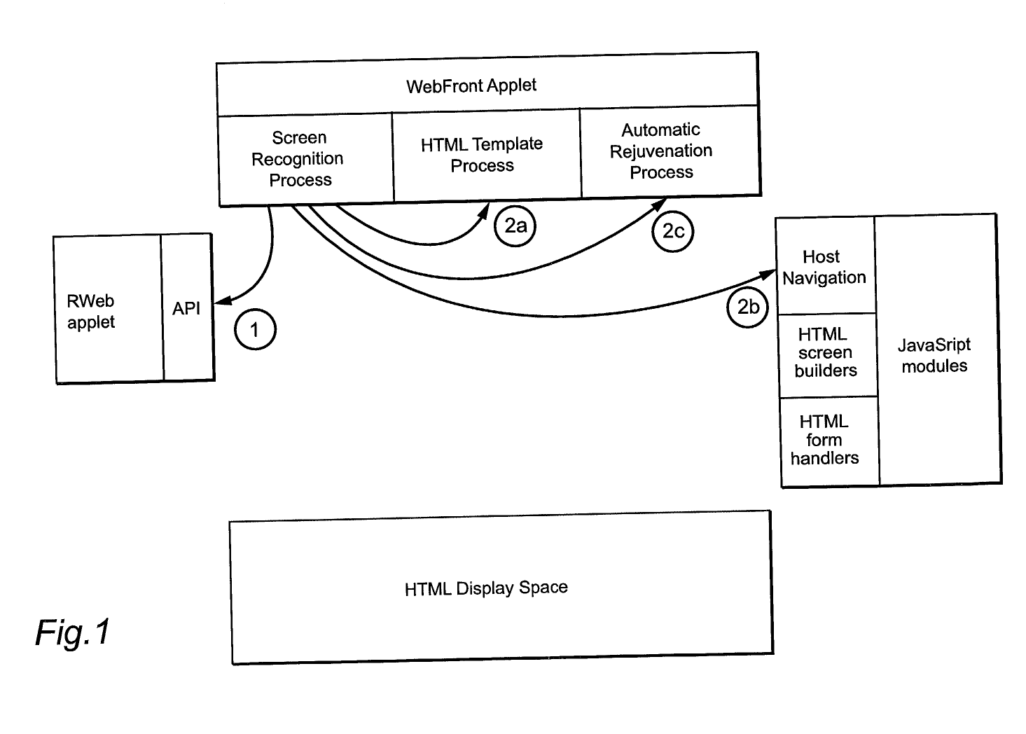

### DETAILED DESCRIPTION OF PRESENTLY PREFERRED EXEMPLARY EMBODIMENTS

The preferred exemplary embodiment of this invention is a technology that presents host (and other) applications in a graphical user interface web (or other) environment. The preferred exemplary illustrative embodiment provides three levels of complexity:

1. Simple screen rejuvenation: automatically represents each host screen in HTML or other standard suitable for display by a web or other browser—displaying unprotected host fields as input boxes, field attributes and colors as HTML styles, and on-screen function key definitions as buttons. No coding is required.

2. Screen customization: Host screens can be customized using JSP (Java Server Pages) templates.

3. Application redesign: Enhances the usability of host applications by re-presenting the application: Combines multiple host screens into a single display, navigates host screens behind the scenes, adds additional business logic, controls access to specific parts of the host application, adds web links and other additional information. For example, JSP templates and “Operations” (navigation instructions read from a model file) are used in the exemplary embodiment to present this redesign.

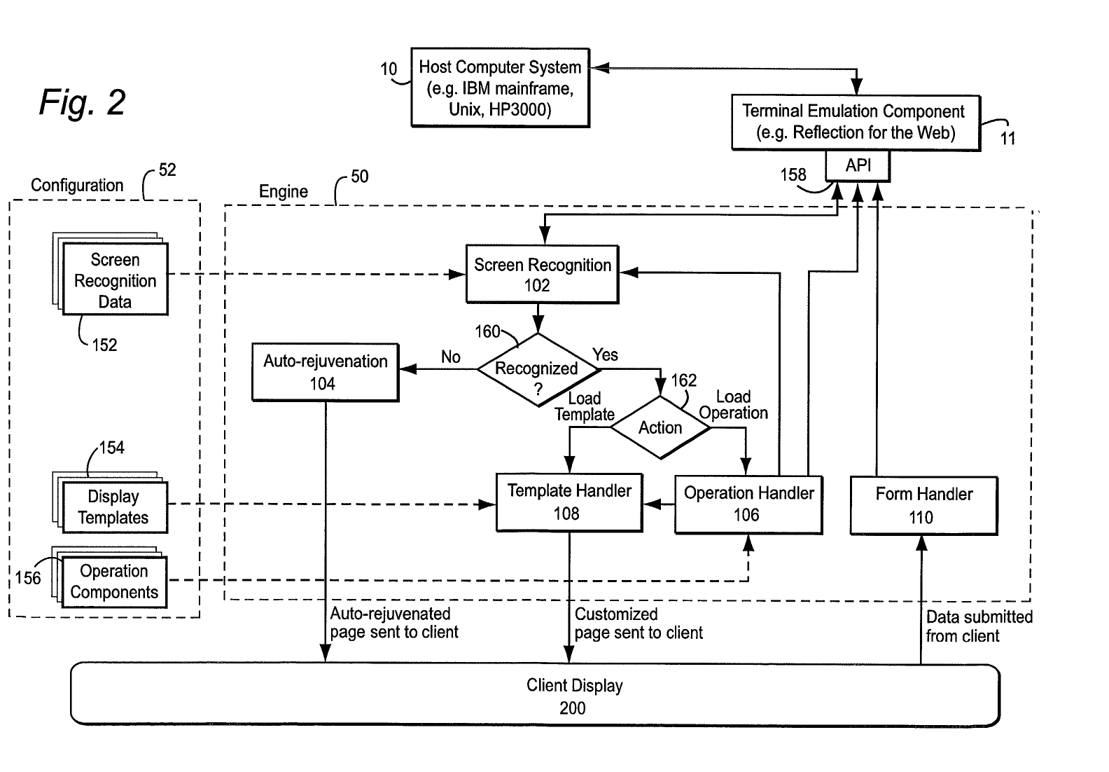

FIG. 2 shows an example overall process provided by a preferred example embodiment in accordance with the present invention. In the example shown, an engine 50 provides the following components and associated process steps:

Screen Recognition processor component/step 102

Screens are registered with this component/step. Each screen is defined by text at row/column positions in the exemplary embodiment. This component receives notification of a new screen event from the Terminal Emulation component/step (11). If a screen is recognized, its associated action is performed. If the screen is not recognized, then the Auto-rejuvenation component may be called.

Auto-rejuvenation processor component/step 104

Called by the Screen Recognition component/step (102) when a new screen is not recognized. Dynamically generates the screen in a graphical format (e.g. HTML, XML) for display on the client (200).

Operation/Navigation handler/function 106

This can be called either by the Screen Recognition component/step 102 (when a new host screen arrives) or by the Form Handler component/step 110 (when the user submits a form). It calls a code module that can perform host navigation through multiple screens, and/or business logic—providing additional graphical user interface flow, context and other functionality. This handler/function 106 is written in Java in the exemplary embodiment, although other languages or conventions could be used in other implementations.

Template handler/function 108

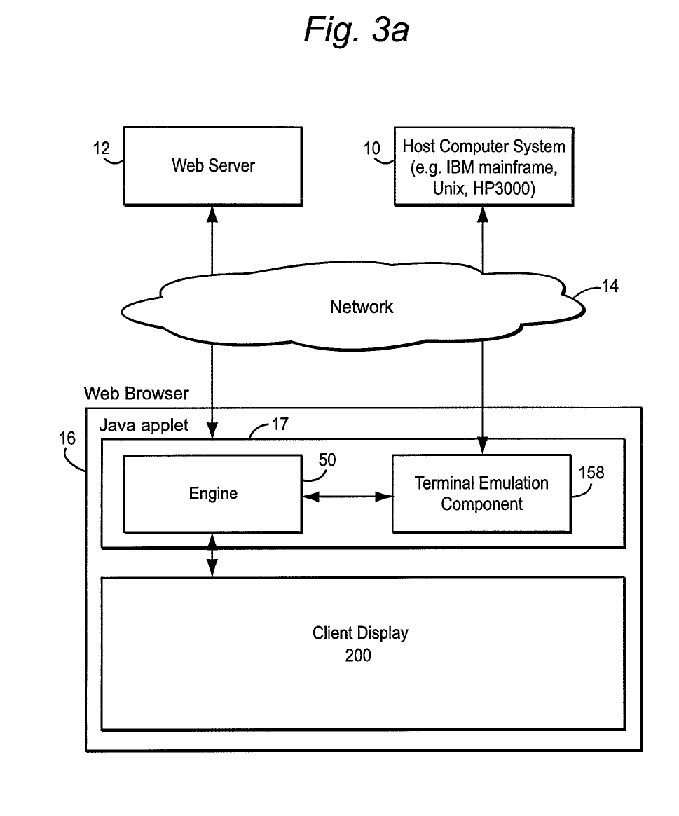

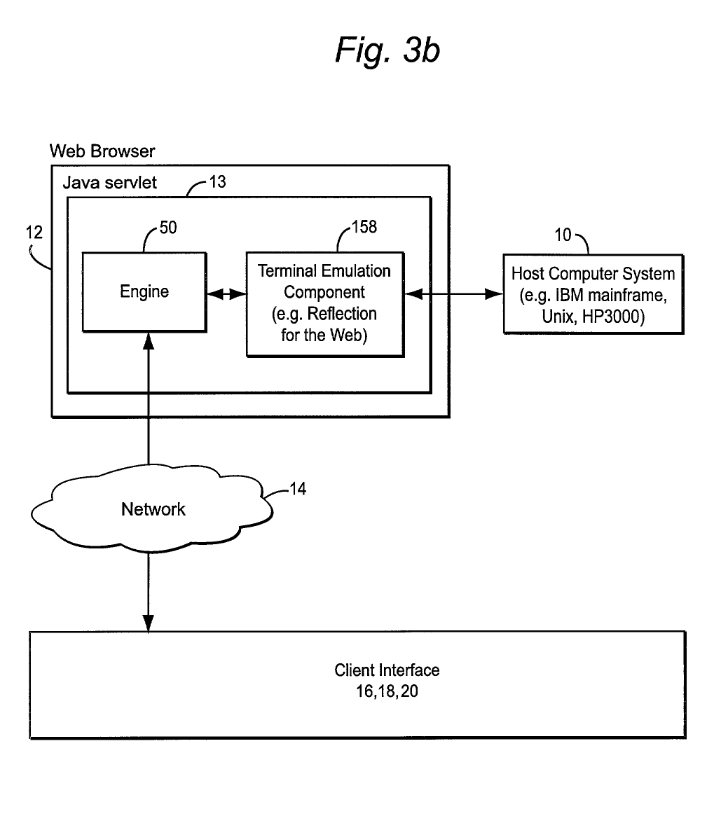

This handler/function 108 can be called by either the Screen Recognition component/step 102 or by the Operation/Navigation handler/function 106. It loads a JSP template for display on the client. When the exemplary embodiment runs on the client (see FIG. 3a) this exemplary handler/function 108 interprets the JSP to insert data from the host screen and/or from the Operation/Navigation component. When the exemplary embodiment runs on a server (see FIG. 3b) the web server/servlet runner interprets the JSP and displays it on the client.

Form handler/function 110

This processes forms submitted from the client. It can either feed the data directly into the host application, or call the Operation/Navigation component/step 106.

In the example shown, additional configuration information 52 may include screen recognition data 152 supporting screen recognition component/step 102; JSP templates 154 supporting template handler/function 108; and operation components/steps 156 supporting the operation handler/function 106.

In the FIG. 2 illustrative example, form handler/function 110, operation handler/function 106 and screen recognition component/step 102 communicate with the host application 11 via a conventional application programming interface (API) 158. In the preferred exemplary embodiment, this application programming interface is a standard conventional API such as that provided by WRQ's Reflection for the Web. In other embodiments, the API could be different or could be customized for particular applications.

In the example shown, generally, the screen recognition component/step 102 is notified by the terminal emulation component/step 11 when a new screen arrives. Screen recognition component/step 102 uses screen recognition data 152 to recognize particular information that is characteristic of particular display screens. In the preferred exemplary embodiment, screen recognition data 152 is preferably preprogrammed (e.g., through a “learning” process or otherwise) to recognize particular screens based on the characteristic information the associated stream from computer 10 contains.

In the exemplary embodiment, if screen recognition component/step 102 does not recognize a particular screen (e.g., the “no” exit to decision block 160), control passes to the auto-rejuvenation component/step 104 which automatically converts the screen into a suitable display format for display by web browser 200. On the other hand, if the screen recognition component/step 102 successfully recognizes the screen format (“yes” exit to decision block 160), then the exemplary engine 50 determines what action to take (load template and/or load operation) in response to such recognition (decision block 162).

In the case of a “load template” operation, engine 50 calls JSP templates 154 to retrieve the corresponding pre-programmed template corresponding to the screen format, and template handler/function 108 then sends the associated HTML form to web browser 200 for display. Alternatively and/or in addition, operation handler/function 106 may determine that a particular operation (which may be implemented using a Java module) may be required in order to process the current screen. Such additional functionality can include for example additional host screen navigation (e.g., to call up one or more successive host screens and extract information therefrom before displaying a screen to the user, or providing other functionality of any desired sort). In this instance, operation handler/function 106 retrieves and loads an appropriate operation component(s) 156 for execution under web browser 200 and/or an associated server 12 depending on the context.

Generally, the user may input information into the display on web browser 200. Form handler/function 110 harvests such “posts” and may provide some or all of the information to host application 11 via API 158. In some circumstances, form handler/function 110 may also provide some of the information received in an http “post” or other responsive information packet(s) to operation handler/function 106 for further processing.

One exemplary implementation uses a custom Java applet (see FIG. 3a) or a custom Java servlet (see FIG. 3b) to communicate with a web-based application such as WRQ's Reflection for the Web to perform some or all of the functionality shown in FIG. 2 (e.g., to generate HTML, XML or other standard format displays as the user interface). Components of this exemplary embodiment include:

Reflection for the Web (RWeb) or other web-based application

A custom Java applet (FIG. 3a) or Java servlet (FIG. 3b)

HTML or other display presentation

Modular JSP and Java components

In the case where the exemplary embodiment “engine” 50 is part of a Java applet 17 (see FIG. 3a), it is downloaded in one illustrative example over the network 14 along with the terminal emulation component 158 from the web server 12 to the web browser 16. The illustrative terminal emulation component/step 158 then establishes a connection back across the network 14 to the host computer system 14. The exemplary embodiment “engine” 50 within applet 17 then interacts with the terminal emulation 158 and the client display 200 to provide a graphical presentation of the host application 11. This is an exemplary two-tier configuration where the client connects directly to the host system. This connection may be secured and encrypted using SSL/TLS or other secure protocol.

In the case where the exemplary embodiment “engine” 50 is part of a Java servlet (see FIG. 3b), an illustrative servlet employs the terminal emulation component/step 158 to establish a session with the host system 10. A user with a client system 16, 18 or 20 establishes a connection across the network 14 and interacts with the graphical presentation of host application 11 via this exemplary embodiment “engine” 50. This is an illustrative three-tier configuration with a server between the client and host system. In this illustrative example, the connection between client and server may be secured and encrypted using HTTPS or other secure protocol.

### ILLUSTRATIVE EXAMPLE RESULTS

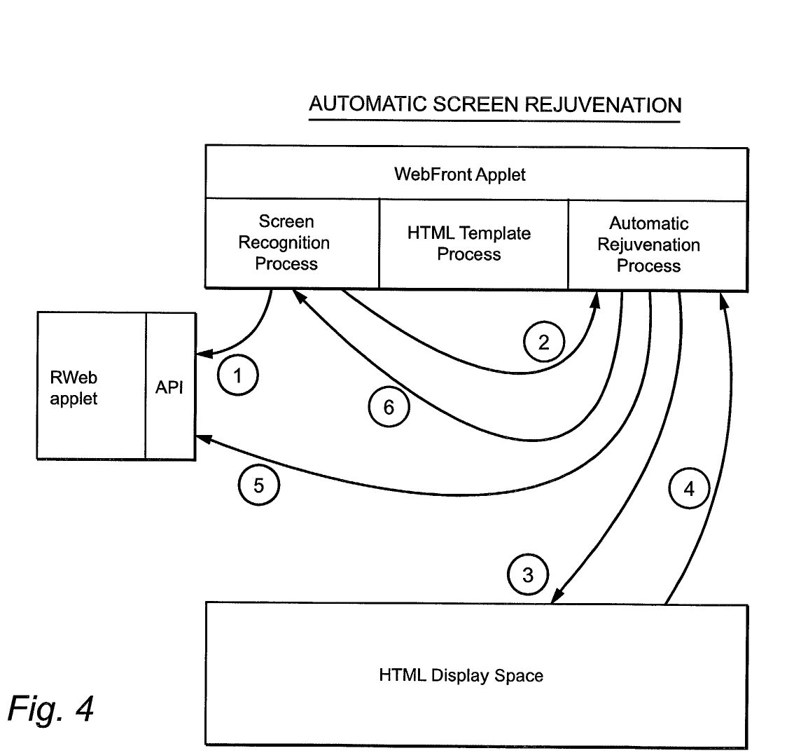

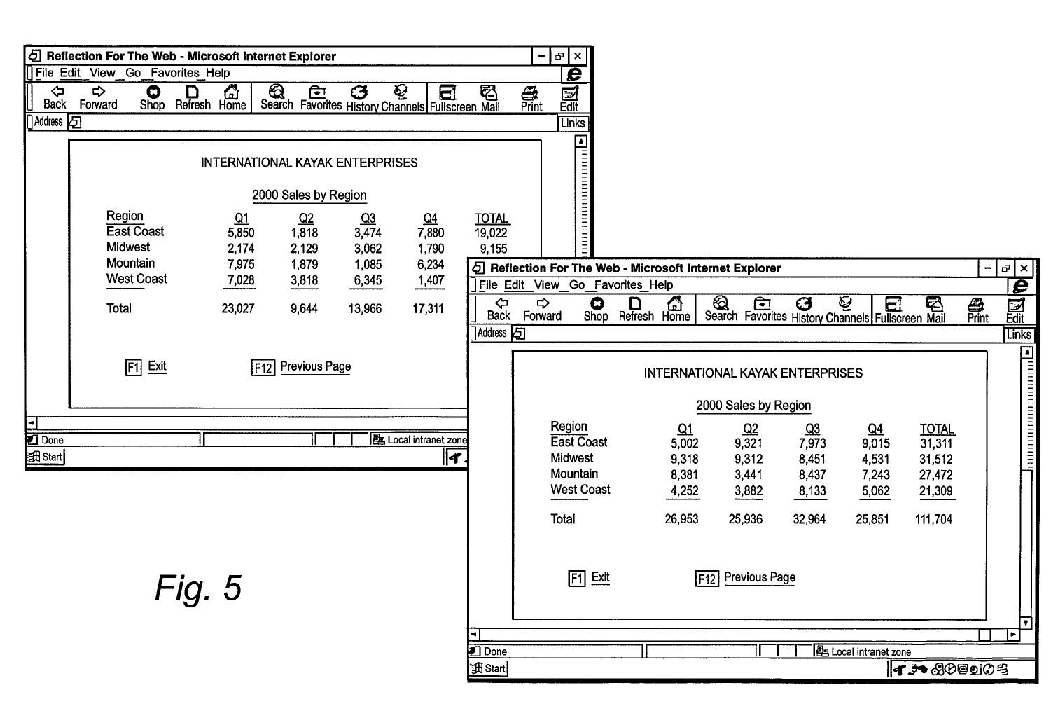

FIG. 4 shows example host screens, and FIG. 5 shows an example corresponding “webified” screen provided by the preferred embodiment of the present invention. Note that in this particular example, the illustrative implementation of engine 50 has merged two host screens (FIG. 4) into a single web page display format (FIG. 5) containing the information from both of the host screens. Such merging of two screens into one involves, among other things, engine 50 providing additional host navigation functionality that automatically sends a simulated user input stream to the host computer 10 to call up a successive host screen so that it too can be scraped of data and the data from the two successive host screens repackaged into a single web page as shown in FIG. 5. Additionally, in this illustrative example, the host screen navigation information (e.g., “previous screen” and “exit”) information is not duplicated on the web page, but rather, is replaced with a web-based “return to main menu” button that can be selected by a mouse or other pointing device.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the scope of the appended claims.

1. A method of converting a first display screen type to a second display screen type comprising:
(a) receiving and recognizing a display data stream representing a first type of display screen;
(b) in response to said step (a), automatically generating a request for at least one successive display screen of said first type;
(c) receiving and recognizing a further display data stream representing said requested at least one successive display screen; and
(d) generating a display screen of a second type different from said first type based at least in part on information contained within said first and further display data streams.

2. The method of claim 1 wherein said steps (a)-(d) are performed at least in part by an applet running under a web browser, and said second type display screen comprises a web page.

3. The method of claim 1 wherein said steps (a)-(d) are performed at least in part by a servlet running on a web server, and said second type display screen comprises a web page.

4. The method of claim 1 wherein said step (b) is performed at least in part by executing a Java or JavaScript program.

5. The method of claim 1 wherein said first type of display screen comprises a terminal emulation session.

6. The method of claim 1 wherein said second type of display screen includes pointer device capabilities

7. The method of claim 1 wherein said generating step (d) includes using JSP templates.

8. The method of claim 1 wherein said step (c) is performed by executing an operation and/or navigation module.

9. A system for converting a first display screen type to a second display screen type comprising:
an applet running under a web browser, said applet receiving and recognizing a display data stream representing a first type of display screen, said applet automatically generating a request for at least one successive display screen of said first type in response to said display data stream, said applet receiving and recognizing a further display data stream representing said requested at least one successive display screen, said applet generating a display screen of a second type different from said first type based at least in part on information contained within said first and further display data streams,
wherein said web browser displays said generated display screen of said second type and permits a user to interact therewith.

10. The system of claim 9 wherein said second type display screen comprises a web page.

11. The system of claim 9 further including a Java applet running under the web browser.

12. The system of claim 9 further including a servlet running on a server.

13. The system of claim 9 wherein said first type of display screen comprises a terminal emulation session.

14. The system of claim 9 wherein said second type of display screen includes pointer device capabilities.

15. The system of claim 9 wherein said applet generates pages based at least in part on JSP templates.
